(19) United States
(12) Patent Application Publication
(10) Pub. No.: US 2022/0222508 A1
(43) Pub. Date: Jul. 14, 2022

(54) SYSTEM FOR SEQUENCING AND PLANNING

(71) Applicant: Soul Machines, Auckland (NZ)

(72) Inventors: Martin Takac, Auckland (NZ); Alistair Knott, Auckland (NZ); Mark Sagar, Auckland (NZ)

(21) Appl. No.: 17/607,648

(22) PCT Filed: Apr. 30, 2020
(86) PCT No.: PCT/IB2020/054122

§ 371 Date: Oct. 29, 2021

(30) Foreign Application Priority Data
Apr. 30, 2019 (NZ) 752901
Jul. 8, 2019 (NZ) 755210

(51) Int. Cl. G06N 3/04; G06N 3/08; G06N 3/00

(52) U.S. Cl. CPC G06N 3/0472; G06N 3/006; G06N 3/08

(57) ABSTRACT

Disclosed is a machine-learning model-based chunker (the “Sequencer”) that learns to predict the next element in a sequence and detects the boundary between sequences. At the end of a sequence, a declarative representation of the whole sequence is stored, together with its effect. The effect is measured as the difference between the system states at the end and at the start of the chunk. The Sequencer can be combined with a Planner that works with the Sequencer to recognize what plan a developing incoming sequence can be a part of and thus to predict the next element in that sequence. In embodiments where the effect of a plan is represented by a multi-dimensional vector, with different attentional weights placed on each dimension, the Planner calculates the distance between the desired state and the effects generated by individual plans, weighting its calculation by the attentional foci.

### TECHNICAL FIELD

The present disclosure is related generally to computing technology and, more particularly, to machine learning.

### BACKGROUND

The goal of chunking is to detect frequently appearing subsequences in a sequential input stream of elements and represent those subsequences as wholes. The representation of a whole chunk can serve for identification, inferring what chunk is being generated after seeing its first few elements, or for generation, serving as a tonic representation of a plan that will guide future generation of a sequence. Generation can either be a replay of a remembered sequence or can feature exploration by picking something other than a winner from a predicted distribution or mixing the distribution with noise. Chunking can also help to increase the sequential memory span, because first-level chunks can serve as input to a second-level chunking mechanism that captures longer-distance dependencies. For example, a first level of chunking in a stream of phonemes may learn words, while a second level learns frequently occurring phrases, such as idioms. Or, in a drawing domain, first-level chunks can be basic strokes like arcs, lines, or simple shapes, and a triangle on a square can form a second-level chunk a house.

The process of ‘chunking’ is the process of learning a declarative representation of a temporal sequence of items. Prior approaches to chunking include neural networks trained to predict the next item in the incoming sequence. Because the next item is often a function of the recent items, neural networks for sequence learning usually use recurrent connections that enrich the immediate input with a context—an exponentially decaying encoding of the history of preceding elements. For example, Elman, J.: Finding structure in time. Cognitive Science 14, 179-211 (1990), discloses a simple recurrent network (SRN) trained with backpropagation of error and using a softmaxed output layer. As long as the output representation is localist, i.e. there is one neuron for each possible next element, the softmaxed output can be interpreted as a probability distribution and standard measures such as entropy or KL-divergence can be applied to it. The SRN trained on the next element prediction task is known to learn transition probabilities between elements.

Reynolds et al (Reynolds, J., Zacks, J., Braver, T.: A computational model of event segmentation from perceptual prediction. Cognitive Science 31, 613-643 (2007)) discloses a SRN augmented with a tonic input that drives the prediction and biases it towards a particular declaratively represented sequence. This was used in a model of event segmentation, where the tonic signal represented an event and significantly helped to stabilise the prediction of the event's elements.

There are shortcomings to the above approaches. First, backpropagation is slow and it takes many training epochs before the prediction reflects transition probabilities implicit in the training data. Second, an SRN operates in one direction only: it predicts the next element of the sequence from the immediate input, the recurrent context and the declarative representation of the chunk. It may be desirable to predict the likely chunk based on the fragment of the sequence seen so far.

Prior approaches to planning systems fail to provide planning that is dynamic and flexible yet computationally inexpensive. Prior approaches also fail to flexibly learn both incrementally and fast (1-shot)—providing Bayesian answers from even a few examples.

### BRIEF SUMMARY

A chunker (the “Sequencer”) learns to predict the next element in a sequence and detects the boundary between sequences. At the end of a sequence, a declarative representation of the whole sequence (the “tonic”) is stored, together with its effect. The effect is measured as the difference between the system states at the end and at the start of the chunk. This can later serve for executing a plan with a particular effect, for recognizing what plan a developing observed sequence can be a part of, and for predicting the effect associated with the recognized plan.

In some embodiments, the Sequencer is implemented as a neural network called a self-organizing map (“SOM”). SOMs can learn from a single training example unlike some other machine-learning models. SOMs can match on an approximation: Even if the inputs are not exactly the same as those seen during training, the SOM may still find a match. Unlike networks trained with backprop, a trained SOM can operate with partial inputs, and reconstruct the missing ones. Unlike a SRN, the sequencing SOM takes the ‘next’ item as one of its inputs.

The Sequencer SOM is, in some embodiments, an attentional SOM (“ASOM”). The effect of a plan can be represented by a multi-dimensional vector, with different attentional weights placed on each dimension.

Any suitable mechanism may be used to set end-boundaries of chunks. In some embodiments, the ending boundary of a chunk is explicitly set by a user. Along with the specifying the end of the chunk, the user may associate a reward with the just-completed chunk. That reward may be used later when deciding on which plan to pursue.

In other embodiments, automated mechanisms may explicitly set ending boundaries of chunks and/or rewards. Thus rewards can be associated with just-completed chunks without any intervention of a user.

The sequential input is first directed to a temporary input buffer in some embodiments. This allows a user to review the input, discard it if necessary, and thus prevent the Sequencer from learning from erroneous data. The presence of the buffer also allows the tonic to be formed only after the entire input sequence is seen.

The Sequencer can be combined with a Planner in some embodiments. The Planner works with the Sequencer to recognize what plan a developing incoming sequence can be a part of and thus to predict the next element in that sequence.

In some embodiments, the Planner pursues a goal by selecting from the plans generated by the Sequencer those plans most closely associated with changing to a state closer to the goal.

In those embodiments where the effect of a plan is represented by a multi-dimensional vector, with different attentional weights placed on each dimension, when the Planner calculates the distance between the desired effect and the effects generated by individual plans, its calculation is weighted by the attentional focus on each dimension to get a modulated encoding of the current reward state, weighted toward the most important dimensions of the desired effect.

The planner can represent chunks more semantically, as plans that have a particular effect on the state of the world, as represented by the agent. In the same way that the planner associates a completed chunk with a reward value, it can also associate a completed chunk with a state update representation, in the Effect input field of the planner. Representation of ‘state’ is very general: it is an n-dimensional vector. Assume a simple state space with six dimensions, each occupied by either 1 or 0. If the agent begins in state [000011], and then performs a sequence of actions associated with a chunk C1, that leave it in the state [110011]. The planner can learn to associate the chunk with a state update operation, that represents the change in state the chunk brings about. The change in state is just the difference (‘delta’) between the two states: in this case, [110000]. The utility in associating plans with state updates, rather than directly with states, is that updates generalise over the elements of the state which a plan leaves unchanged, and focus on the elements that need to be changed. Say the agent has the goal of achieving state [110000], and it is currently in state [000000]. The cblock computes a goal state update (in this case, [110000]), and then presents this goal update in the Effect input field to the planner, as a query. Even though during training, chunk C1 resulted in the state [110011]—which is different from the current goal state the planner is queried with a desired change in state, and the planner can retrieve chunk C1 from this query. The overall paradigm here is that at the end of each chunk, the C-block computes a new goal state update, by taking the difference between the goal state and the current state, and then presents this goal state update as a query to the planner. The ‘full’ goal state update might decompose into several separate state updates, which are associated with distinct chunks. This is the equivalent of a partially ordered plan at the higher level, where some actions can be taken in an arbitrary order. For instance, if the planner has learned two chunks, associated with updates [110000] and [001100] and the agent is currently in state [000000], and desires to be in state [111100], both chunks will be (somewhat) activated, and can be performed in either order.

When the Planner is implemented as an ASOM, in some embodiments, the Planner may be interpreted as a device computing Bayesian probabilities. The Planner can make probability distributions rather than simply taking a single best fit when helping the Sequencer to predict the next element in a developing input sequence or when choosing which plan to activate. The cblock generates a Bayesian prediction about the most likely next item, and makes inferences about the plan that likely generated the sequence thus far, and the likely effect of this inferred plan.

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 is a generalized schematic of a combined chunker/planner according to certain embodiments presented in the current disclosure;

FIGS. 2a through 2e together form a flowchart of a representative method for directing behaviour; and

FIG. 3 is a block diagram of a representative system incorporating a combined chunker/planner according to certain teachings in the present disclosure.

### DETAILED DESCRIPTION

Turning to the drawings, wherein like reference numerals refer to like elements, techniques of the present disclosure are illustrated as being implemented in a suitable environment. The following description is based on embodiments of the claims and should not be taken as limiting the claims with regard to alternative embodiments that are not explicitly described herein.

In the current disclosure, embodiments of the chunker and/or planner are referred to as “cblock.” This term should be taken very generally, with various embodiments supporting various combinations of the features discussed here.

In its various embodiments, cblock can:
learn sequential dependencies in incoming sequence data and predict a probability distribution over possible next inputs,
detect repeatedly occurring sequences in the input, automatically detect sequence boundaries based on surprise in prediction, “reward”, or on explicit user input, and represent sequences as chunks, often called “plans,” for future execution or replay,
associate plans with rewards and with their effects on the system state,
recognize a possible plan from partial data and recognize the intent, that is, the effect, and expected reward from a fragment of an ongoing input sequence, and
implement goal-driven behaviour by finding and executing a plan that reduces most differences between a current system state and a desired state; differences between states can be weighted by individual attentional weights (“alphas”).

In some contexts, the elements of a temporal sequence can be thought of as actions that have an effect on the global state of the system, whatever that state is. Learned chunks then correspond to plans that take the system from one state to another. The planning component of cblock learns associations between chunks and their effects (potentially including an externally provided reward signal). This allows the cblock to operate in a goal-driven mode, wherein it selects a plan supposed to reduce as effectively as possible the differences between the system's current state and a desired goal state, or a plan most likely to bring about an expected reward. Plan selection is dynamic: each time a plan completes (or fails), the new current state is used to recompute a new difference between the current state and the goal state, and the plan which most effectively reduces this new difference is selected.

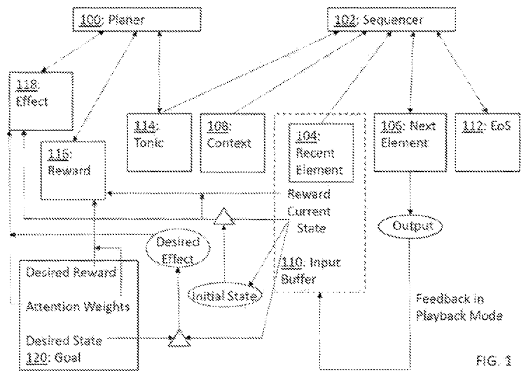

FIG. 1 illustrates the major components and data flows within cblock. The two central components are the machine-learning models Planner 100 and Sequencer 102. The techniques of the present disclosure may be embodied in any of several types of machine-learning models. Machine learning models include unsupervised sequence-learning and clustering systems, neural networks, recurrent neural networks (“RNNs”), simple recurrent networks (“SRNs”), convolutional neural networks (“CNNs”), long short-term memories (“LSTMs”), gated recurrent units (“GRUs”), SOMs, ASOMs, generative topographic maps (“GTMs”), elastic maps, oriented and scalable maps (“OS-Maps”), support vector machines, random forests, linear regression, logistic regression, Bayesian decision trees, and other machine-learning models or adaptations. An attentional SOM (ASOM) as described facilitates regulation of which of

When learning, Sequencer 102 receives sequential input 104 and divides that input 104 into meaningful plans. Sequencer 102 in conjunction with Planner 100 constantly predicts the next element 106 in the sequence it is receiving. Because the next element 106 may rely on more than the immediately preceding element, Sequencer 102 maintains a context 108 an exponentially decaying encoding of the history of the preceding elements.

For example, if Sequencer 102 has been trained to predict the final “S” in the word JAMES, then next 106 contains “S,” recent 104 holds “E,” and the context 108 is a representation of “M”+c*“A”+c^2*“J”+c^3*previous, where previous is whatever preceded J, and c<1 is a decay coefficient. When the next element arrives, the context 108 is multiplied by c, and the recent element 104 is added to it; then the just-arrived next element becomes the new recent 104, and Sequencer 102 starts again to predict the next element.

In some embodiments, when the next element 106 is not as predicted, Sequencer 102 is “surprised” and terminates the plan at that point. In other embodiments, Sequencer 102 may be surprised, but it does not terminate the emerging plan. In these embodiments, the incoming sequence is stored in a temporary input buffer 110 controlled by a user. The user reviews the incoming sequence and tells Sequencer 102 when the plan is complete by sending an explicit end-of-sequence (“EoS”) control message 112. Because EoS 112 happens after the last element in the sequence, it can be stored as a separate transition in Sequencer 102. Hence, Sequencer 102 predicts all the elements in the sequence and then the EoS after the last element, e.g., J→O→H→N→EoS.

In a similar vein, the user can declare that a plan is complete because the plan has achieved a certain result which is generally associated with a positive reward 116 or a negative punishment.

The buffer 110 allows the user to choose to discard a “bad” input sequence without having Sequencer 102 learn it at all, thus preventing Sequencer 102′s learning from becoming cluttered with meaningless plans.

The buffer 110 also separates prediction from learning the input sequence. Each new incoming element 104 is added to the buffer 110 and to the evolving declarative/tonic representation 114 of the whole sequence. When the user decides to finalize the sequence, the buffer 110 contains the sequence as it actually happened along with its recorded declarative representation 114.

With each new incoming element 104, cblock tries to predict the most likely next element 106. For this it uses both Sequencer 102 and Planner 100:

If the element 104 that just arrived is not surprising, cblock takes the tonic representation 114 in the buffer 110 and queries Planner 100 for a complete plan consistent with the fragment so far received. Then Sequencer 102 takes the retrieved plan together with the current context 108 and the recent inputs 104 to predict the most likely next element 106, which can be a proper one or EoS 112.

In some embodiments, the prediction from the previous time step and the actual element 104 are compared based on a sliding average of KL (Kullback and Leibler) divergence. If that divergence is greater than a threshold, then cblock signals a surprise. It sets Sequencer 102's alpha for the tonic input 114 to zero and tries to predict the most likely tonic 114 from the recent element 104 and its context 108. This soft-output tonic 114 is then used to query Planner 100 for the hard-output best-matching stored plan. This plan is in turn sent hack to tonic input 114 of Sequencer 100 where it uses the context 108 and the recent element 104 to predict the next element 106.

Thus, because the sequence elements and the actual tonic 114 are stored in the buffer 110, Sequencer 102's inputs can be tweaked in any desirable way to help the prediction without affecting Sequencer 102's learning.

The buffer 110 also allows the tonic 114 to be used only after it represents the entire sequence. With the buffer 110, Sequencer 102 is only trained after the whole sequence has been seen, i.e., when the user decides it is complete and sends the EoS 112 command to finalize it, so the training tonic input 114 is the same for all transitions and is equal to the one that will be used during replay: the complete declarative representation.

Because the presence of the buffer 110 means that the sequence ends only when the user says so, a reward 116 or state change 118 due to the sequence can arrive after the last element in the sequence and indeed can inform the user's decision to end the sequence at this point.

Associating a reward or punishment 116 with a plan is discussed above. In some embodiments, a change of state 118 is associated with a plan. Cblock keeps track of the initial state when a plan begins and, at the end of a plan, subtracts from the final state, that is, the result, that initial state from the beginning of the plan. This difference is the net effect 118 of the plan. The triangle on the line in FIG. 1 between the Initial State and the effect 118 indicates this net difference or delta. Thus, the state change 118 for a plan need not result in an ultimate goal but may be a step contributing toward reaching a goal. The plan is stored along with its net effect 118, tonic 114, and reward 116, if any, in Planner 100.

The tonic 114 serves as a signature for a plan. The tonic 114 evolves based on the input and over-represents the first few elements in the sequence with subsequent elements decaying into the future. In this way, the tonic 114 and the context 108 form complementary representations decaying in opposite directions.

In embodiments that use surprise to find a plan boundary, the decaying nature of the tonic representation means that if there hasn't been a surprise for a very long time, then the tonic representation 114 stops changing, and Sequencer 102 is no longer being trained until the next surprise. To deal with this case, a limit on plan length may be introduced: If the magnitude of the decayed recent element 1004 is below a certain threshold value, then the current plan is terminated as if there were a surprise. The effect of this is that Sequencer 102 can learn several different fragmentations of a predictable plan, e.g., how to draw a heart from different parts.

The tonic 114 is useful for making predictions that are more sophisticated than ones based simply on the most probable next element in a sequence. For example, the most frequent first letter in English is “S,” the first pair is “ST,” and the first triple is “STR.” The tonic 114 allows for predictions beyond “street” or “string.”

As a result of Sequencer 102's learning a plan, Planner 100 receives the tonic 114 when the plan is complete. In association with the tonic 114, Planner 100 also receives the reward 116 and the state-change effect 118 of the plan.

In some embodiments, cblock supports at least the operational modes: “goal-driven” (generation mode) and “goal-free” (observation mode).

In one embodiment, cblock supports a “collaboration mode” which is a combination of observation and generation: the cblock observes a fragment of a sequence and makes inferences about the likely plan (and goal) that produced it. Depending on the certainty of the inference, the cblock can adopt the inferred goal and generate the rest of the sequence.

In goal-free mode, cblock learns as described above. When in goal-free mode, cblock does not follow a predetermined plan but can try to match the unfolding input sequence against already known plans and make a prediction based on the most likely match or distribution of most likely matches. This lets cblock collaborate with the user. If, for example, the incoming sequence to date is “STETHOSC,” then cblock can recognize that this is most likely the plan “STETHOSCOPE” and complete it.

In either the goal-free or goal-driven mode, the predicted next element 106 can be fed back to the input for the next step, as shown in FIG. 1. This feedback can be used for collaborative action. For example, while a user is providing sequential input, cblock passively observes and stores the input in the buffer 110. If the user stops for some reason, and if cblock can predict what is coming with a high degree of certainty, then cblock can wait a while for the user to resume and, if that does not happen, turn on the playback mode.

When in goal-driven mode, Planner 100 attempts to achieve an alpha-weighted desired goal 120 and activates the best-matching plan or plans to achieve that goal 120. Planner 100 uses the information received from Sequencer 102 in two ways:
(1) When cblock observes a fragment of an incoming sequence, it can predict not only the full plan from the fragment but also the expected result and reward. If the Bayesian feature, discussed below, is enabled, then Planner 100 predicts the expected values of the effect 118 and reward 116 for all plans consistent with the fragment as seen so far. Otherwise Planner 100 returns the reward 116 and effect 118 for the best matching stored plan. Thus, Planner 100 helps Sequencer 102 to infer a distribution over possible plans that are consistent with the recently observed sequence of items and to reconstruct the missing input. This probability distribution then allows cblock to switch between generating behaviors, possibly selecting a plan that matches the overall distribution rather than a single best fit, and interpreting inputs to implement joint action with its interlocutor: having inferred a plan, cblock can act in accordance with that plan.
(2) In goal-driven mode, Planner 100 is queried for a desired result, reward, or combination of the two, and Planner 100 returns the plan best-matching the query. The tonic 114 of the plan is then sent to Sequencer 102 which can replay the plan.

The effect 118 makes this goal-driven planning more accurate because the same effect applied to different initial states might yield different results. During plan selection, cblock computes the difference between a desired effect and the effect 118 generated by a specific plan, using the difference to find plans that bring about the desired effect. Whenever a plan is completed, it may bring about a change in the current state. At that point, cblock re-evaluates the difference between the desired effect and the effects of individual plans, trying to find a plan to eliminate any remaining differences. In this way, planning is dynamic, watching what differences are left and trying to eliminate them.

When an embodied autonomous agent is pursuing a goal 120, the desired effect may be represented by a vector in a multi-dimensional state space of factors, such as needs and desires, personal or commercial. Not every aspect of the current state is equally relevant to the agent at any given time, and the embodied agent may attend to different aspects of the state vector at different times. At any given moment, an agent may care more about some of these dimensions than others, that is, some dimensions may have a greater “attentional focus.” Therefore, when calculating the distance between the desired state and the effects 118 generated by individual plans, the calculation is weighted by the attentional focus on each dimension to get a modulated encoding of the current reward state, weighted toward the most important dimensions of the goal state. This multi-dimensional calculation is also used when determining whether a goal has been reached.

As cblock activates a plan to pursue a goal or to reap a reward, it may sometimes determine that the plan should be dropped. For example, the plan should be dropped if the goal associated with that plan has been achieved. In other cases, a plan could be dropped (a) if the plan's steps have been completed, but the goal has not been achieved, (b) if something particularly unexpected happens, or (c) if a timeout occurs. When a plan is dropped, cblock generally searches for another plan to move it toward the goal. To make sure that cblock does not choose the plan that it just dropped, that plan is “inhibited,” that is, it is associated with a time-decaying inhibition trace that decreases, for a time, the plan's likelihood of being re-selected. This improves variability in cblock, allowing it to try viable alternative plans to reach the goal.

In some situations where an activated plan is dropped, rather than simply choosing another plan to reach the goal, cblock might select a new goal to pursue, or it could simply leave the goal-driven mode and await further developments.

The Attentional SOM thus regulates which of {Tonic, Context, Recent, Next} in the Sequencer or (Reward, Effect, Tonic} in Planner are actual inputs and which are queries to be reconstructed from the inputs, and enables weights to be changed depending on the task (e.g. goal-driven by reward vs. effect). If Planner and Sequencer by any other machine learning model supporting or modified to support mechanisms for dynamically shift the emphasis and regulating what is input and what is output.

As just one non-limiting example of the issues involved in choosing one machine-learning model over another, an embodiment where Planner 100 and Sequencer 102 are implemented as ASOMs rather than as SRNs provides the following advantages in some potential situations:

(a) SRN's back-propagation requires multiple training iterations, but SOMs can learn very quickly, even from a single training example. This helps when a user tells cblock what to expect by entering explicit examples.

(b) SOMs can match on an approximation: Even if the inputs are not exactly the same as those seen during training, the SOM may still find a match. This feature adds a great deal of flexibility when attentional weights are placed on different parts of the input.

(c) A SOM may store its memories in the weight vector of each unit in the map. This permits a dual representation: The SOM's activity represents a probability distribution over multiple options, but each option's content is stored in the weights of each unit and can be reconstructed top-down. Unlike in an SRN with tonic input, the SOM can be trained on sequences with tonic input, and then when the trained SOM is exposed to the first few elements of a sequence, it can reconstruct the tonic input top-down.

(d) The Bayesian feature mentioned above allows cblock to make probability distributions rather than simply taking a single best fit. An ASOM may be interpreted as a device computing Bayesian probabilities.

Each trained SOM represents a particular class of inputs in its weights. When providing the SOM with a new input plan, the SOM can find the most likely class the plan belongs to. In the standard Bayes' rule:

$$p ( {h}_{i} \vert d ) = \frac{p ( d \vert {h}_{i} ) \cdot p ( {h}_{i} )}{p ( d )} \qquad ( 1 )$$

$$p ( {h}_{i} \vert d ) = \frac{p ( d \vert {h}_{i} ) \cdot p ( {h}_{i} )}{{\sum }_{j = 1}^{N} p ( d \vert {h}_{j} ) \cdot p ( {h}_{j} )} \qquad ( 2 )$$

where:
p(hᵢ\d) is the posterior probability of the i-th hypothesis given the data d; that is, the probability that the SOM's current input is an instance of the class represented in the weights of the i-th neuron,
p(d\hᵢ) is the likelihood of the data if hi was true,
p(hᵢ) is the prior probability of the i-th hypothesis, and
p(d) is the probability of observing the data d.

The activity Aᵢ of each unit is computed as:

$${a}_{i} = exp ( - c \cdot {d}^{2} ( \vec{x} , \vec{{w}_{l}} ) ) \cdot {m}_{i} \qquad ( 3 )$$

$${A}_{i} = \frac{{a}_{i}}{{\sum }_{j = 1}^{N} {a}_{j}} \qquad ( 4 )$$

where d²( [symbol] )s is the squared alpha-weighted Euclidean distance between the input x and the weight vector wᵢ, aᵢ is the un-normalized activity of the i-th unit, mᵢ is the activation mask component for the i-th unit, and Aᵢ is a resulting normalized activity, so that the activities of all the SOM's units sum to 1. Comparing the first set of equations with the second set, the mᵢ component corresponds to the prior probability of the i-th hypothesis/neuron, so by specifying the activation mask, a prior bias is induced on the ASOM even turning parts of the map off, if zero prior probabilities are assigned to them. The Gaussian term exp (-c⋅d²( [symbol] )), where c is the sensitivity of the Gaussian and is inversely proportional to its width, nicely fits in place with the notion of the likelihood p(d\hᵢ). The denominator in Formula (4) is a total response, that is, the sum of un-normalized activities of all neurons, of the map to the current input and corresponds to Σⱼ₌₁^{p}(d\hⱼ)⋅p(hⱼ)=p(d), which is just the probability of the data itself. A very low total activity in the map indicates strange or novel input data. This cumulative activity can also be used for meta-level competition between different SOMs. Normalized activity of the whole SOM corresponds to the posterior probability distribution over all the hypotheses/neurons given the current input data.

The output of the SOM can be made to compute an activity-weighted combination of the weights of all the neurons:

$$\vec{y} = {\sum }_{j = 1}^{N} {A}_{j} \cdot \vec{{w}_{j}} \qquad ( 5 )$$

which, if the SOM's activity is interpreted as a probability distribution over possible hypotheses about the input, corresponds to the expected value of the input given the distribution.

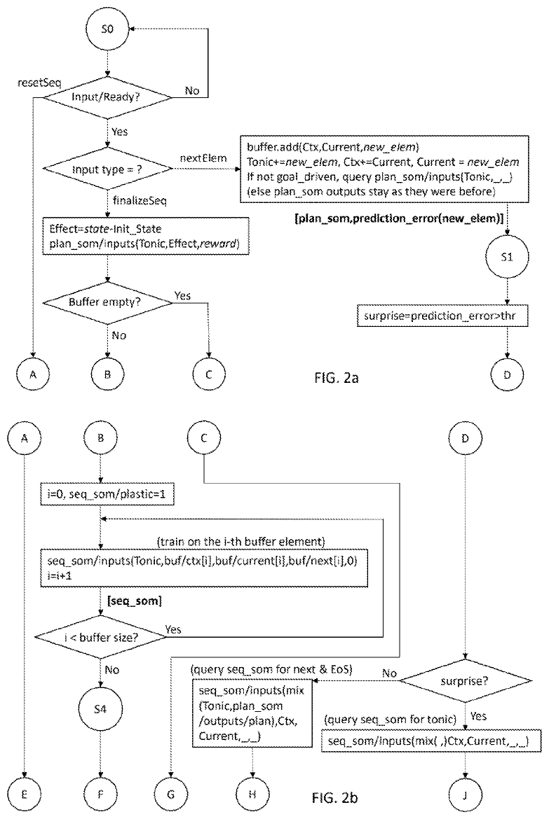

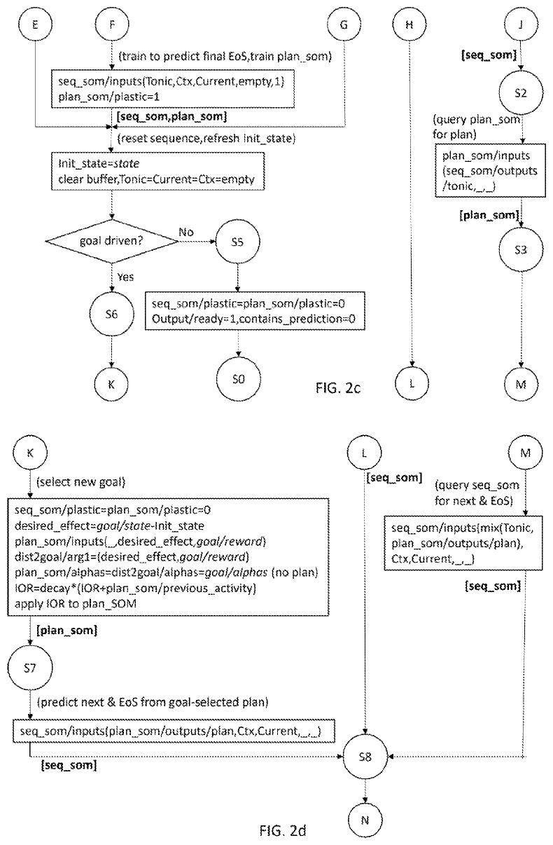

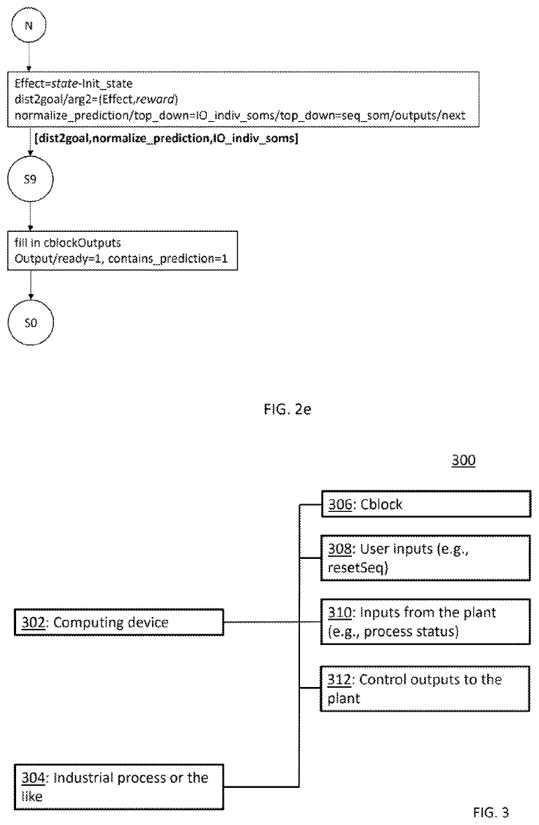

FIGS. 2a through 2c illustrate a flowchart of an embodiment of cblock. The flowchart illustrates only one embodiment and is not intended to limit the claimed invention. In this particular embodiment, Planner 100 and Sequencer 102 are implemented as SOMs and are called “Plan_SOM” and “Seq_SOM” respectively.

Cblock Inputs: Cblock can take three kinds of input, whenever cblockInputs/ready is set high:
inputType_nextElem: a new element has arrived,
inputType_resetSeq: a control signal saying that the buffer contents should be discarded without training Seg_SOM, and
inputType_finalizeSeq: a control signal saying the sequence in the buffer was successful and should be stored in Seq_SOM, and the plan, effect, and reward are stored in Plan_SOM.
   In an embodiment, exactly one of these three variables should be set to 1.

State and reward can be connected all the time, changes to them do not require raising the ready signal, but cblock only attends to them when needed:
when finalizing the sequence to compute its effect and to store it along with the reward and plan in Plan_SOM,
when starting a new sequence to remember its initial state, and
with the arrival of a new element in goal-driven mode to check whether the goal has been reached.

Cblock Outputs: Regardless of which of the three types of input arrived into cblock, cblock always signals that it has finished processing by setting cblockOutputs/ready. When resetting the sequence, there is no new prediction, and cblock just acknowledges that the discard has been completed. If the input was finalizeSeq, then whether or not there is a meaningful prediction depends on the operational mode. If cblock is operating goal-free, then there is no meaningful prediction from the EoS signal, and the ready just acknowledges that sequence learning is complete. In goal-driven mode, each time a sequence is finalized, cblock refreshes its goal buffer and re-computes a new plan. A new plan leads to a prediction of its first element, so here there is a valid prediction. And there is always a valid prediction for a nextElem input. Whether cblockOutputs contains a valid prediction is signaled by cblockOutputs/contain_prediction: A 0 means that the predicted element should be ignored.

When there is a valid prediction, it is a prediction of either a proper element or of an EoS. This is signaled by cblockOutputs/eos_predicted: High means the predicted element should be ignored.

With a prediction, good_enough, plan_good_enough, and goal_reached are returned. Goal_reached is a discrete 0 or 1 variable signaling whether the goal_alphas-weighted match between the desired [effect, reward] and the actual [effect, reward] is bigger than a threshold. At the same time, the output variable goal_reached_degree contains a continuous (0-1) value of the match, whether or not it exceeded the threshold. This value can serve as a reward in goal-driven mode. In the case of playback, the predicted element should only be executed and sent back to the input if (a) good_enough is set, i.e., there is low entropy, (b) plan_good_enough is set, which is always the case in goal-free mode, and in goal-driven mode is based on the over-threshold value of un-normalized activity of the best matching neuron in Plan_SOM, i.e., whether the retrieved plan satisfies the requirements well, and (c) goal-reached is not set, that is, do nothing if the difference between the desired and current states is below a threshold. However, this happens outside cblock, so it is up to the user to decide how to use these values or whether to ignore them.

Cblock also signals when the incoming element was surprising and what plan it is most likely a part of.

Cblock's Control-Cycle Flowchart and Notation Notes: Cblock is event-driven. Cblock is driven by a state machine. All states are only executed when needed, dependent on the state variables. These are called S0 through S9 and are depicted as large circles. The smaller circles each containing a capital letter are simply connectors between the pages making up the flowchart. The code executed in each state is in the rectangular box on the section of the arrow path between the state and the following one. The SOMs and other functions perform their operations where marked in [square brackets]. If the transition to the next state depends on a condition, the conditional is in a diamond.

Input variables that come from outside cblock are in italics. Internal variables usually start with capital letters. Seq_SOM inputs are written as arguments in parentheses in this order: seq_som/inputs(tonic, context, current, next, EoS). Plan_SOM inputs are written in this order: plan_som/inputs(plan, effect, reward). Elements with zero alpha are replaced with underscores (_).

Operation: Cblock normally waits in state SO listening for cblockInputs/ready. When that is received, cblock takes action depending on the input type. For nextElem, the new element is added into the buffer and variables Tonic, Context, and Current are updated accordingly. Cblock evaluates the surprise as an over-threshold difference between the prediction from the previous cycle and the newly arrived element.

If cblock is surprised, it configures alphas for Seq_SOM to pay the most attention to the current element, a bit less to the context, and zero to the tonic. It infers the likely tonic top-down as a soft output, i.e., a distribution. The inferred distribution is then run through Plan_SOM to de-noise it. Plan_SOM also returns a soft output. Then Seq_SOM is queried again conditioned on the inferred distribution of tonic plans and with normal alphas to predict the next element or EoS. The tonic input of Seq_SOM is a linear combination or “mix” of the observed Tonic and the plan inferred through Plan_SOM. The mixing coefficient of the plan is 1 in goal-driven mode, otherwise it is 1-plan_som/activation_entropy, which is entropy of the normalized activation map (vector of all Ai in Equation 4 above) of Plan_SOM. Thus the more certain Plan_SOM is, the higher the influence. Cblock then evaluates the distance to the goal, when it is in goal-driven mode, fills in cblockOutputs, signals output ready, and returns to S0.

If there is no surprise, cblock uses Plan_SOM to infer the most likely plan from the observed Tonic and then predicts the next element or EoS conditioned on the Tonic, Context, and Current element. Cblock evaluates the distance to the goal, when in goal-driven mode, fills in cblockOutputs, signals output ready, and returns to S0.

If the input type was resetSeq, cblock clears the buffer and resets Tonic, Context, and Current, and there is no training. Cblock also records the current state as the initial state in preparation for the next input chunk. If operating goal-free, cblock then signals cblockOutputs/ready without prediction and returns to SO. If goal-driven, cblock selects a new goal, picks up a plan, and predicts its first step. This operational branch is in common with finalizeSeq, so it is described below.

If the input type was finalizeSeq, cblock evaluates the effect of the plan by recording the reward and the effect as the difference between the current state and the initial state recorded at the start of the chunk. It also trains Seq_SOM on the contents of the buffer and to predict EoS at the end. Then cblock clears the buffer, resets Tonic, Context, and Current, and records the new initial state just as in the resetSeq branch. Calling finalizeSeq with an empty buffer is equivalent to calling resetSeq. In goal-driven mode, it is now time to select a new plan: Cblock reads in the desired goal state, reward, and attentional alphas for their components. It computes the desired effect as the difference between the desired state and the current one. Next it queries Plan_SOM for the best plan conditioned on these constraints. The best-plan selection can be influenced by inhibition of a previously winning plan via the activation_mask, which is the vector of all mᵢ of Equation 3 above. Seq_SOM is then queried for the next element or EoS conditioned on the selected plan and on the initial Context and Current. The result is returned in cblockOutputs, and cblock returns to S0.

Besides responding to an externally triggered reset or finalize, cblock has an internal timeout on plan execution. This is measured by a leaky integrate-fire (“LIF”) neuron whose speed can be controlled by the user or disabled. Each time the LIF fires before a natural plan ending, usually (a) by goal_reached, (b) by predicting EoS, or (c) by any other external factor that triggers finalizeSeq, it internally triggers resetSeq. In goal-free mode this only clears the buffer, but in goal-driven mode it also refreshes the goal and selects a new plan.

Inference of the Most Likely Plan, Effect, Reward: Because Plan_SOM is queried for a stored plan consistent with the evolving fragment, a side effect of this is intention recognition: Whether cblock is surprised or not, it returns on its output also the most likely effect and reward that a retrieved plan was stored with. This is helpful in goal-driven mode: If cblock is pursuing a plan to satisfy a goal but is surprised, for example because the plan is an alternating sequence of user/cblock actions as in a dialog, and the user does something unexpected, then it tries to recover by inferring the most likely new plan and reacts consistently with that. At the same time, cblock signals surprise and returns the most likely effect and reward, so that the user can decide whether to insist on following the original goal or to go along with the new plan. Here the control is also with the user: It is up to the user to set the planning/goal input in the next step and to discard or finalize the sequence.

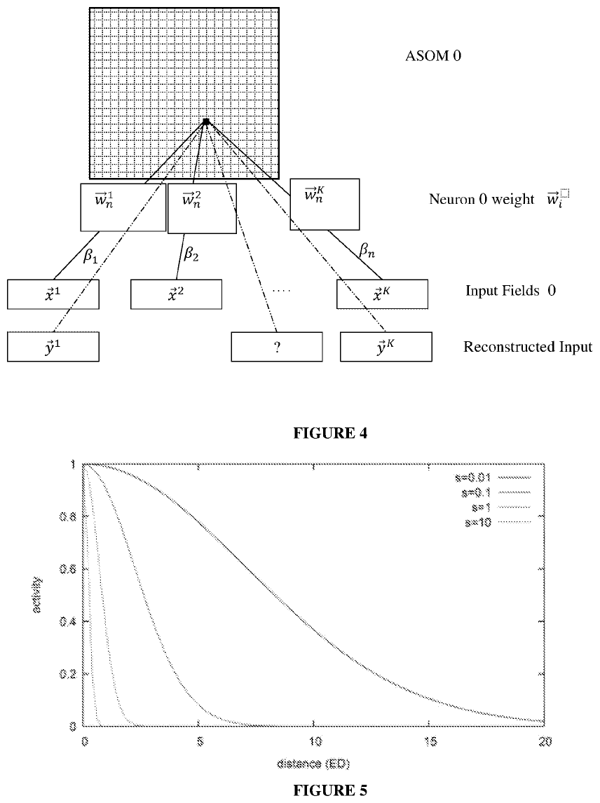

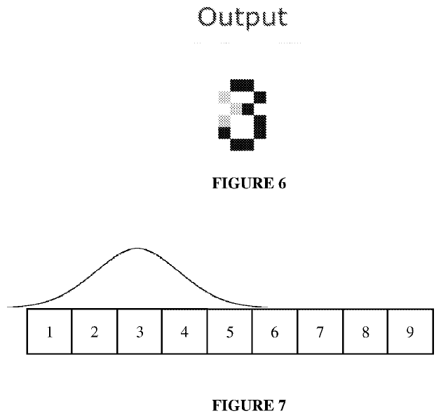

FIG. 3 is a stylized representation of one environment 300 in which cblock can work. Here, an instance of cblock 306 is running in a suitable computing system 302 in order to control an industrial plant 304.

Cblock 306 is trained in what to expect for normal operations in the plant 304. The training and set up can include associating attentional weights to various sensor inputs that cblock receives. For example, when a fire is detected, responding to that emergency is more important than meeting a standard production schedule.

When operating, a user gives cblock 306 the types of inputs 308 discussed above but may also provide other control information such as which process the plant 304 is currently running, what production inputs are on hand or being delivered if that information is not otherwise available to cblock 306, etc.

Cblock 306 receives production and other status information 310 from the plant 304 on an on-going basis. In a sophisticated plant 304, this may include information from thousands of sensors of various types including cameras and other physical sensors. As discussed above, cblock reviews this input as “plans” and responds to set goals and rewards by sending control outputs 312 to the plant.

While industrial process control is one fruitful area for the application of the techniques of the present disclosure, other areas are arising as well. Cblock can be configured to control dialogue systems and/or online planning or collaboration applications such as remote document-editing applications or form-filling applications.

In an embodiment of dialogue systems, the cblock can be used to combine sequence-learning and reinforcement-learning approaches to learning dialogue management strategies with elements of a plan-based dialogue model. Like a plan-based system, it is possible to infer the user's plan (and ultimately, the user's goal) in making an utterance, or a sequence of utterances, and cooperatively help pursue the inferred plan, and/or goal. Also like a plan based system, but unlike the learning systems, it is possible to represent alternative possible plans. Unlike plan-based systems, but like reinforcement systems, it is possible to learn “good” plans, that lead to reward, from exposure to training dialogues. In addition, like sequence-learning systems, it is possible to learn simple conventions about how utterances in a dialogue are sequenced.

Cblock can thus be used to control autonomous agents, such as sophisticated avatars, that interact with human beings using natural language and other human-centric cues (thus improving human computer interaction). For example, in an embodiment an avatar implemented using cblock helps users fill out an online form. Externally to the cblock, the avatar is trained to recognize a set of user utterance meanings that may arise during a user/avatar dialog about the form. The avatar is also given a set of utterances it can produce itself in the dialogue. The set of user utterance meanings, plus the set of avatar utterances, collectively form the items that are ‘sequenced’ by the cblock. In addition to this, a goal is associated with the completion of each field of the form and with completing the entire form. The cblock is trained on sequences of user utterance meanings and avatar utterances, coupled with tonically active user intents, and transient rewards triggered by the achievement of goals. It learns to represent subdialogues featuring the user and avatar that lead to reward as chunks. Learned subdialogues are assigned multi-dimensional effects that represent movement toward a goal. Attentional foci are set to represent the relative importance of various dimensions of the multi-dimensional state vectors.

During a user/avatar dialog, the avatar has a set of candidate goals to be achieved: in the present example, form fields to be filled in. The avatar has at least two strategies. In a first strategy, the avatar waits for an utterance from the user, and when one arrives, uses the cblock to match this utterance to one of the learned subdialogues that leads to a goal. If the avatar finds a match, the avatar can progress this subdialogue, by producing an utterance if it is the avatar's turn, or waiting for an expected user utterance. In the second strategy, the avatar actively selects a goal, for which the avatar produces the first utterance in the associated dialogue, produces this utterance, and then progresses the subdialogue as before.

In either case, if the subdialogue fails to go to plan, cblock will register surprise. It can recover in two ways, depending on its setting of the goal-free/goal-driven parameter. In goal-free mode, it can perform a Bayesian calculation, to determine whether the user has embarked on a different subdialogue (that is, a different chunk). In goal-driven mode, it can attempt to get the original subdialogue back on track, by repeating an earlier utterance in the current plan.

At any point in the dialogue, cblock can activate an expected probability distribution over likely user utterance meanings for the next user utterance. This can provide a top-down prior to the utterance interpreter that sits outside cblock, that can help disambiguate if there are multiple possible bottom-up interpretations of the incoming user utterance.

During a user/avatar dialog, the avatar responds to expected inputs from the user by giving the user guidance as to how to proceed in filling out the form. The user's input may include direct questions that cblock ties to the goal of filling out a particular field. Other user inputs may be vague or incomplete but may still be recognized from cblock's training: Here, cblock may recognize an incomplete response, fill in the missing parts, and proceed as if the user had entered the entire plan.

As each plan is completed or field is filled in, cblock may change the attentional weights, select a new plan, and activate it, proceeding in this manner until the ultimate goal, the filling in of the entire form, is reached.

However, the user may provide input beyond the range of cblock's understanding, that is to say, cblock is surprised at the user's input. Cblock can drop any existing plans and recover by performing a Bayesian calculation of probabilities of what the user may mean. Depending upon the outcome of that calculation, cblock may have a good, but not perfect, idea of what the user is saying and may prompt the user for clarification.

In extreme cases, cblock may have to proceed to activate a generic response such as “I'm sorry, I didn't understand that. Would you please rephrase your question?” The user's response may allow cblock to find an appropriate plan or lead it to abandon the project of filling in the form entirely.

If the dialog proceeds to a successful filling in of the form, cblock recognizes that state and, depending upon the specifics of the application, may engage the user in further dialog about other goals.

Different cblock instances may be used for sequencing an embodied autonomous agent's own motor movements, and for sequencing a wide variety of events the embodied agent can perceive in the world, from low-level events involved in the production of facial expressions, to high-level events associated with utterances in a dialogue.

The cblock may endow an autonomous agent with reinforcement based chaining. For example, an embodied autonomous agent may learn sensorimotor sequences to discover rewards. A chunk may serve as a motor schema: a high-level representation of actions that guides generation of the sequence. The use of a neurobehavioral modelling framework to create and animate an embodied agent or avatar is disclosed in U.S. Pat. No. 10,181,213B2, also assigned to the assignee of the present invention, and is incorporated by reference herein. A cblock integrated into such an embodied autonomous agent may learn specific sequences of action-outcomes which lead to a major action-outcome which is associated with a reward. For example, an agent interacting with a set of buttons may learn that pressing certain buttons in a certain order creates a certain result, which may be associated with a plan. Then, by setting the result as a goal, the agent may look for each button in turn to press the buttons in order and satisfy its goal. Within a neurobehavioural model such as that described in U.S. Pat. No. 10,181,213B2, ‘reward’ signals may be implemented as virtual neurotransmitter levels—e.g., virtual dopamine levels.

The cblock may be implemented in autonomous agents with decision-making abilities to weigh up different criteria or courses of action based on available knowledge, towards a desired goal (i.e., neuroeconomics). Thus an agent can learn various plans (sequences of steps) to achieve various goals, and then evaluate (decide) which one of the plans to activate based on multiple dimensions (i.e., weighing up many different factors). The goal of an artificial agent may be internally generated (e.g., if hungry get food) or externally given (e.g., if asked to do a task by a user). An agent's goal may change in real-time. For example, if its level of hunger increases over the course of executing a task, the agent may interrupt the task and change its goal to find food. As described herein, the cblock allows agents to recognize possible plans, intents (effects) and expected rewards from a fragment of an ongoing sequence. They can then implements goal-driven behavior, learn sequential dependences in incoming data and predict probability distributions over possible next inputs. They can notice repeatedly occurring sequences, automatically detects sequence boundaries (based on surprise in prediction) and represent sequences as chunks/plans for future execution/replay.

Agents can make guesses about another entity's plan (e.g., another agent, or a human user), from the actions they are doing. Since the same network that controls the passive inference of plans also controls the active adoption and execution of plans, this supports a neural model of collaboration, whereby an agent can both recognize another entity's plan, and then help to achieve it.

In another embodiment, cblock is used to learn musical sequences and variations. Musical input may be received by cblock where the musical input may comprise, for example, a sequence of musical elements such as notes and rests. The notes and rests may be processed by Sequencer to predict the next note or rest and also detect the boundary of a musical phrase. The Sequencer may predict the current musical phrase based on the context and tonic and input the musical phrase to the Planner as the tonic. The Planner may predict the following musical phrases. Moreover, cblock may be used for music generation by using its goal-driven mode. A goal may be input to cblock, and cblock may generate musical phrases from the Planner to achieve the goal. In some embodiments, a starting point may be selected by providing a partial input of one or more musical phrases, and cblock may complete the musical composition by selecting additional music phrases that achieve the goal in light of the partial input. The goal may comprise, for example, a particular result or a reward. In music generation mode. cblock may successfully generate a complete musical composition, song, or sequence.

It will be understood that many additional changes in the details, materials, steps, and arrangement of parts, which have been herein described and illustrated to explain the nature of the invention, may be made by those skilled in the art within the principle and scope of the invention as expressed in the appended claims.

### Detail of Modified Self-Organizing Maps According to one Example Implementation

### Weighted-Distance Function

In traditional SOMs, the dissimilarity between an input vector and a Neuron's weight vector is computed using a simple Distance Function (e.g. Euclidean distance or cosine similarity) across the entire Input Vector. However, in some applications, it may be desirable to weight some parts of the Input Vector (corresponding to different Input Fields) more highly than others.

In one embodiment, an Associative Self Organizing Map (ASOM) is provided, wherein each Input Field corresponding to a subset of the Input Vector contributes to a Weighted Distance Function by a term called ASOM Alpha Weight. The ASOM computes the difference between the set of Input Fields and the weight vector of a Neuron not as a monolithic Euclidean distance, but by first dividing the Input Vector into Input Fields (which may correspond to different attributes recorded in the Input Vector). Differences in vector components in different Input Fields contribute to total distance with different ASOM Alpha Weights. A single resulting activity of the ASOM is computed based on the Weighted Distance Function, wherein different parts of the Input Vector may have different semantics and their own ASOM Alpha Weight values. Thus, the overall input to the ASOM subsumes whatever inputs are to be associated, such as different modalities, activities of other SOMs, or anything else.

FIG. 4 shows an architecture of an ASOM, integrating inputs from several modalities.

The input \vec{x} to the ASOM consists of K Input Fields 0. Each Input Field is a vector \vec{x}^{k} of dimₖ Neurons for i=1 . . . K. An Input Field 0 may be:
A direct 1-hot coding of sensory input;
A 1D probability distribution
A 2D matrix of activities of a lower-level self-organizing map,
   Or any other suitable representation.

The ASOM 0 of FIG. 4 consists of N Neurons, each Neuron i=1 . . . N having a weight vector \vec{w}ᵢ corresponding of the full input, divided into K Input Fields of partial weight vectors \vec{w}ᵢ^{k} for k=1 . . . K. When an input \vec{x} is provided, each ASOM Neuron first computes a Input Field-wise distance between the input and the Neuron's weight vector:

$$Dist ( \vec{x} , \vec{w} ) = {\sum }_{k = 1}^{K} {α}_{k} * {dist}_{k} ( {\vec{x}}^{k} , {\vec{w}}^{k} )$$

where aₖ is a bottom-up mixing coefficient/gain (ASOM Alpha Weight) of the k-th Input

Field. distₖ is an Input Field-specific Distance Function. Any suitable distance function or functions may be used, including, but not limited to:
Euclidean distance
KL divergence
Cosine based distance

In one embodiment, the Weighted Distance Function is based on Euclidean Distance, as follows:

$$Dist ( \vec{x} , \vec{w} ) = \sqrt{{\sum }_{i = 1}^{K} ( {α}_{i} ) {\sum }_{j = 1}^{{D}_{i}} {( {x}_{j}^{( i )} - {w}_{j}^{( i )} )}^{2}}$$

where K is the number of Input Fields, aᵢ is the corresponding ASOM Alpha Weight for each Input Field, Dᵢ is the dimensionality of the i-th Input Field and xⱼ⁽ⁱ⁾ or wⱼ⁽ⁱ⁾ is the j-th component of the i-th Input Field or a corresponding Neuron weight respectively.

In some embodiments, the ASOM Alpha Weights may be normalized. For example, where a Euclidean distance function is used, the activity ASOM Alpha Weights is usually made to sum to 1. However, in other embodiments, ASOM Alpha Weights are not normalized. Not normalizing may lead to more stable Distance Functions (e.g. Euclidean distances) in certain applications, such as in ASOMs with a large number of Input Fields or high-dimensional ASOM Alpha Weight vectors dynamically changing from sparse to dense.

Examples of benefits and uses of Weighted Distance Functions are as follows:
1. ASOM Alpha Weights may be set to reflect the importance of different layers.
2. ASOM Alpha Weights may be set to ignore modalities for specific tasks.
3. ASOM Alpha Weights may be used to model attention—can dynamically assign attention/focus to different parts of the input, including shutting off parts of input and predicting input values top-down. An ASOM Alpha Weight of 0 acts as wildcard, because that part of input can be anything and it will not influence the similarity judgment delivered by the Weighted Distance Function.
4. Accommodate Input Fields with different numerical properties in terms of variance.
5. Accommodate Input Fields representing different modalities.
6. ASOM Alpha Weights may be set to counterbalance differently sized Input Fields.

For example, if one layer is a bitmap of 400 neurons (where a difference in 20-50 pixels would still be considered a small one), and another layer is a binary flag, then the difference in the second layer would be neglected if the Input Fields were equally weighted. To make them comparable, the first Input Field may be set to, for example, 50 times smaller than the second Input Field.

ASOM Alpha Weights influence the grouping of representations on the SOM during training. For example, if there are two Input Fields, the first representing a rich distributed vector of properties of an object and the second representing a 1-hot type label, by setting the ASOM Alpha Weight for the first to zero, inputs will be grouped by labels, i.e. all inputs with the same label would train the same Neurons, hence effectively computing the moving average/prototype of the rich property complex in the first Input Field. In an example with multiple output options (e.g. an Autonomous Agent sees a face and should return a person/ID), a localist coding (one Neuron per person) may be used for these options. This ensures that during training, only the Neuron for the right person will be active (1-hot coding) and during retrieval, joint activity of localist ID neurons would represent a probability distribution over whose face it is (using a Probabilistic SOM as described herein).

ASOM Alpha Weights can be set dynamically to retrieve associations, allowing situational queries or using the ASOM as input-output mapping for arbitrary domains. It is possible to compute a pattern of activation in an ASOM from just some selected input fields, by setting the Alpha/Input Field weights for the remaining fields to 0. An ASOM pattern can be activated from an incomplete input pattern, missing certain fields altogether. Having activated an ASOM pattern, it is possible to reconstruct patterns in the missing input fields, either from a single winning Neuron, or, in Bayesian fashion, from the full pattern of ASOM activity. In this manner, the ASOM may be used as a device for supervised learning. Some of the ASOM's fields are inputs, and others as outputs. During training, all the inputs and outputs are provided. When the network is used with new test inputs, the ASOM Alpha Weights of the output fields are set to 0 and the SOM activity is used to reconstruct values in these output fields.

For example, an ASOM is provided for associating two Input Fields (faces and names).

During training, inputs associating the two Input Fields are provided. However, in testing/reconstruction/retrieval, only a face may be provided, and the ASOM should retrieve a corresponding name for it. To do so, the ASOM Alpha Weight for names may be set to a wildcard (e.g. set to 0) temporarily.

Learning Frequency Constants can be different for each Input Field to combine quick (1-shot) learning (high learning frequency constant) for some Input Fields Input Fields (like label/name) with more gradual learning of the content associated with the label (e.g. a visual representation, or other features). Lower learning frequency means that the content will over time become an average of all inputs for which this neuron was a winner—a sort of a prototype. Fast learning means the weights are overwritten with the most recent input. Thus fast learning and slow learning can be combined within one learning exposure.

### Activation Mask

An Activation Mask is a mask on SOM competition or activation which regulates which parts of a SOM are allowed to compete and to what extent. It is thus possible to:
selectively turn on/off the whole areas of the SOM
grow a map when full (an activation mask may restrict the area of the SOM that is allowed to learn. If the area that is allowed to learn gets full, the Activation Mask can change to “add” new map areas.)
clamp the activity to a certain area
implement IOR (inhibition of return) to create variability in SOM behaviour
perform sequential iterative search through multiple alternatives.

Each Neuron of the SOM may be associated with a Mask Value. The Mask Value is a modifier on the neuron's activation, i.e. it determines to what extent its corresponding Neuron can be activated (with 1 meaning it is activated as normal, and 0 it is impossible to activate). The Mask Value may be a single variable, which may be a binary value, or a continuous value between 0 and 1.

The entire collection of Mask Values is the Activation Mask which is isomorphic with the

SOM map, in other words, there is one Mask Value for each Neuron. The Activation Mask biases the competition for the Winning Neuron (or activation, for a probabilistic SOM), wherein Neurons with a 0 Mask Value are totally excluded from competition; Neurons with Mask Values<1 are disadvantaged.

Activation Masks may be applied situationally to regulate competition for any suitable purpose, including, but not limited to: inhibition of return of recently active neurons, implementing Bayesian priors, implementing a growing map, turning on and off different areas of the map, and restricting competition to trained neurons (an application of Bayesian priors based on Training Record) which helps to get much cleaner output.

### Probabilistic SOM

In classic SOMs, the SOM's activity is a selection of the Winning Neuron based on the minimal Distance (or other similarity function) between the input and each Neuron's weights. All computations are performed in the distance space.

In a Probabilistic SOM, the activity of the Probabilistic SUM measures the response of each Neuron in the Probabilistic SOM to a particular Input Vector, gated between a [0-1] range. Self-Organizing Maps are adapted to make fuller use of their localist nature, by calculating the output of each Neuron in such that each Neuron holds a detailed representation in its weights (i.e. a complete representation of a given input pattern in its weight vector), yet multiple Neurons can be active simultaneously, to different degrees, creating an “activation map”. Adapting SOMs in this manner allows the expression of ambiguity, probability distributions, mutually competing alternatives, and for implementing Bayesian computations.

Neurons in a Probabilistic SOM represent alternative possible hypotheses about the input pattern—and can thus be interpreted as expressing a probability distribution over these hypotheses. The pattern of activity in the Probabilistic SOM is interpretable as a combination of several independent ‘basis vectors’ represented in the weights of these Neurons. These interpretations can only be regarded as approximate: since nearby Neurons represent similar patterns, the hypotheses they encode are not fully exclusive (or equivalently, the basis vectors they represent are not fully orthogonal). Nonetheless, Probabilistic SOM activity patterns can be treated both as probability distributions over possible inputs and as coarse-coded representations of inputs.

The Probabilistic SOM's activity (“activation map”) reflects the similarity (e.g. which may be an inversely proportional function of Euclidean Distance) between the Input Vector and Neurons' weights transformed into a [0,1] space via an Activation Function, and all computations occur in the [0,1] activation space. In Probabilistic SOMs, the activity of Neurons is proportional to the similarity between their weight vector and the input to the SOM. The activity is bounded between 0 and 1, where 1 corresponds to the maximum similarity (identity). In one embodiment, the activity of the SOM is a Gaussian function of the Euclidean distance between the input vector and the weight vectors of each of the neurons. For example, an Activation Function to calculate the activation of a Neuron aᵢ may be:

$${a}_{i} = {e}^{- {sDist}^{2} ( {a}_{i} , {\vec{w}}_{i} )}$$

Where aᵢ represents the activity of a given neuron i, with weight vector \vec{w}ᵢ for an input vector \vec{x} and s is the sensitivity/width of the Gaussian, Dist is the distance function used (which may be a standard Euclidean Distance or Weighted Distance Function as described under the heading Weighted-Distance Function). a is a vector of activities for all Neurons in the SOM. Neurons with weights that are relatively close to the Input Vector produce an activity close to 1, and Neurons with weights that are further away output values closer to 0. Alternative similarity functions can be used instead of a Gaussian, such as cosine similarity, which reduces aᵢ to dot product of input s and weight vector w if both are normalized to have unit length. In embodiments where the Activation Function is not a Gaussian, (and is an exponentially decaying function) the Dist does not have to be squared as in the Gaussian Activation Function formula.

Similarity metrics/distances are converted to activations, and the sensitivity of matches may be regulated by modifying a Sensitivity s, which in Gaussian activation functions represents the width of the Gaussian. Each SOM Neuron can be thought of as encoding a ‘prototype’ input pattern in its weight vector. Neurons reacts with an activity proportional to the likelihood that the current input is an instance of this concept. Under this interpretation, the Sensitivity controls how close to the prototype an input must be in order for the Neuron to react strongly (how “picky” the Neurons are). FIG. 5 shows activity distributions, based on sensitivities of 0.01, 0.1, 1, and 10, demonstrating how the Sensitivity value regulates how “picky” the Neurons of the Probabilistic SOM are. The Sensitivity s may be adjusted based on the nature of the input; e.g. its typical variation in terms the Distance Function used (e.g. Euclidean distance). If the Sensitivity is high, Neurons react with almost zero to everything but the prototypes; if low, the decrease in activity will be more graded. In Gaussian Activation Functions, there is a plateau near this prototype (i.e. at Euclidean distances close to 0). This plateau corresponds to the range of Euclidean distances that are close enough to generate a high response. At larger distances, there is a steep drop in its response, and it asymptotes to 0.

In a non-Probabilistic SOM, the metric for determining the Winning Neuron is the minimum weighted distance between the input and weight vectors. In a Probabilistic SOM, the metric for determining the winning Neuron may be either the minimum distance between the input and weight vectors, or the maximum activation of the Neuron.

Provided the Probabilistic SOM is trained on training items with mutually exclusive classes, the normalized activity of the Probabilistic SOM generates a probability distribution. Each Neuron in the SOM can be considered a hypothesis within the distribution, and when normalized, the new activity of each Neuron represents the probability of its hypothesis. Thus, in order to interpret a SOM activity pattern as a probability distribution, a further bounding is to constrain the activity of all Neurons to sum to 1. Activations may be normalized (e.g. softmaxed), such that the activity over the entire Probabilistic SOM (activation map) sums to 1. The final Activity of the Neuron i can be calculated by ensuring the activity of all j Neurons sum to 1, using an equation as follows:

$${A}_{i} = \frac{{a}_{i}}{Σ {a}_{j}}$$

It is possible to add priors to the calculation of the activity. The prior bias of each Neuron may be added to equation. It is possible to set the priors to be the relative frequency of the SOM Neurons, recorded as a count of the number of times each unit won the winner-take-all competition during training. This updated formula follows Bayes' rule and represents the posterior probability distribution over the inputs into the SOM. If each neuron in the SOM represented a label, then we can interpret the activity as the probability that the input x belongs to one label or another.

Normalizing activities of the neurons over the whole SOM simulates the result of a time-stretched lateral inhibition/competition. When activity is normalized, it can be treated as a probability distribution over hypotheses represented in the weights of different Neurons.

Normalization is useful for entropy calculations. When activity is normalized, entropy over the activity of SOM Neurons can be used to derive a measure of the SOM's ‘confidence’ in its understanding of a given input. Confidence is high when entropy is low, and vice versa. Normalization also allows reconstruction of inputs from a pattern of SUM activity, in a way that closely approximates Bayesian inference. Interpreting the output of a SOM as a posterior probability distribution enables the calculation of the relative entropy of the activity to determine the degree of ambiguity in the distribution. The total number of Neurons j may be used as the base of the logarithm to ensure the entropy always ranges between [0,1] where the maximum entropy (ambiguity) is 1.

$${A}_{i} = - {\sum }_{i = 0}^{j} {a}_{i} {log}_{j} {a}_{i}$$

Kullerback-Leibler (KL) divergence may be used to determine the relative entropy between Probabilistic SOM activity distributions.

Finally, normalization may be useful for soft output reconstruction/reconstruction of inputs from a pattern of Probabilistic SOM activity. Top-down reconstruction of inputs is achieved by presenting a partial input, and eliciting a Bayesian activity distribution in the SUM, and using the output to reconstruct the expected input for that distribution. With an activity, it is possible to calculate the expected value of the hypothesized posterior x:

$$x = {Wa}_{i}$$

Normalizing is useful when treating neurons as mutually competing alternatives (e.g.

classifying input as A or B but not both, prior to normalizing). For example, where different Neurons represent different, mutually exclusive, object types. If neurons are feature detectors wherein features may be present in parallel (e.g. detecting nose, mouth, and two eyes within an image of a face), it may be desirable not to normalize.

In summary, the Probabilistic SOM can be useful in any application wherein multiple active

Neurons can represent probable alternative explanations, for example: decision making, sentence meaning interpretation, face recognition.

As with standard SOMs, during the weight update step, the weight vectors are updated to become closer to the input vector, weighted by a Gaussian function centred on the winning Neuron. A parameter sigma controls the spread of the Gaussian function and is typically made to decrease in size over a training period. This allows areas of the map to specialise into different inputs while grouping similar inputs together on the map.

### Bayes' Rule

Each trained SOM Neuron in a Probabilistic SOM can be treated as representing the prototype of a class of inputs in its weights. When providing the SOM with a new input (data), the most likely class (hypothesis) it belongs to can be found, following Bayes' rule as described above. In a Probabilistic SOM, the activity Aᵢ of each Neuron is computed as:

$${a}_{i} = {e}^{- s {D}^{2} ( \vec{x} , {\vec{w}}_{i} )} {m}_{i}$$

$${A}_{i} = \frac{{a}_{i}}{Σ {a}_{j}}$$

aᵢ is the unnormalized activity of the i^{th} Neuron, mᵢ is the prior probability of the i^{th} Neuron/hypothesis and Aᵢ is the resulting normalized activity so activities of all Neurons sum to 1.

There are various ways of combining these two conditional probability distributions. For example, two conditional probabilities may be provided using a simple weighted sum (where the contribution of the top-down distribution is specified by a “top down influence” parameter). Another option is a weighted product, as described by Hinton, 2002. (G Hinton. Training products of experts by minimizing contrastive divergence. Neural Computation, 14:1771-1800, 2002)

By specifying an Activation Mask mᵢ, a prior bias is induced on the ASOM (even turning parts of the map off, if zero prior probabilities are assigned to them). In other words, the activation mask represents “prior beliefs”. The Gaussian term e^{-s}D²(\vec{x}, \vec{w}ᵢ) aligns with the notion of the likelihood p(d\hᵢ).

The denominator in the formula for normalized activities Aᵢ is a total response (sum of unnormalized activities of all neurons) of the map to the current input (activation sum)—and is the probability of the data itself—corresponding to p(d).

Thus, Neurons of computation are not representations of specific objects, locations, actions or events, but rather full probability distributions over these items. Bayesian computations retain at each stage a notion of many possibilities, and of the agent's confidence in which of these possibilities are more likely. Inference mechanisms can change which possibilities are regarded as likely and can change the Autonomous Agent's confidence about various estimates being made. Indeed, the agent can become very confident in her estimates—for instance, the Autonomous Agent can be very certain it has seen a dog at a given location. But Bayesian computations also allow the Autonomous Agent to express states of low, or intermediate confidence, or indeed of complete ignorance.

### Soft Output

When a SOM is presented with input it reacts with activity in parts of the map with neuron weights similar to the input. The activity itself is a representation of beliefs about the nature of input and can serve as input to higher-levels SOM. But a SOM can also return its estimate of the reconstructed input (remember that input can be noisy or incomplete and can differ from the patterns the SOM has been trained on). We call such a reconstruction the “output” of the SOM.

The output of a SOM may the Winning Neuron's weight vector, i.e. the SOM will return the closest of the remembered values, regardless of activities of any neurons other than the winner.

The output of a Probabilistic SOM can be a weighted combination of the activities of each Neuron multiplied by their weight vectors. Normalized activity of the whole SOM corresponds to the posterior probability distribution over all the hypotheses/neurons given the current input/data. Once an Input Vector elicits an activity pattern over the Probabilistic SOM, the input may be reconstructed in a top-down manner. The weight vectors of all Neurons may be combined with a mixing coefficient equal to the Neuron's activity. Interpreting the SOM's activity as a probability distribution over possible hypotheses about the input, corresponds to the expected value of the input given the distribution:

$$\text{Expected Value} = {\sum }_{j = 1}^{N} {A}_{j} \cdot \vec{{w}_{j}}$$

This can be thought of as a “soft output”, reconstructed from all weights as an expected value conditioned on the probability distribution in the ASOM's activity landscape, computed as an activity-weighted combination of all weight vectors. An output representation may be built from several “basis” functions represented by simultaneously active Neurons. For example, a face-to-person association can be mediated via several ASOM Neurons, if the face images for the person are too different to be represented by a single neuron, yet would result in activating the same person on the output.

In an example where inputs to the Probabilistic SOM are bitmaps of numbers: if an input is the digit 3, the area of the map representing 3's will show large activation, and other digits similar to 3 in shape, such as 8 (and maybe 9 to a lesser degree) may also be activated. Thus, the activity map may be bimodal or trimodal. If the ASOM recognized its input as the digit 3 with probability 0.51 and 8 with probability 0.49, the output would be 3 if no soft output is used. If soft-output i s used the resulting output may be a visual blend between the digits 3 and 8, as shown in FIG. 6.

FIG. 7 shows a SOM with nine Neurons with hard-coded weights between 1 and 10. Numerical (rather than image-based representations of digits) inputs are directly provided to the SOM, which is a 1D SOM having 1-dimensional inputs. Inputs to the SOM are sparsely coded (representing real numbers by a population code, i.e. a sparse vector. This is an example of how soft output can be used reconstruct inputs with good precision. When an input corresponding to x=3 is provided, the Neuron with hard-coded value 3 will be the most active, however there is a gradient of activity surrounding that Neuron. Increasing the Sensitivity would result in only Neuron #3 is active. Providing an input x=3,7, if only the Winning Neuron is used to determine the output, the value 4 would be returned, as Neuron #4 is the “Winning Neuron”, having the closest value to the input. Using Soft output/Expected Value, the exact value of the input 3.7 can be reconstructed (e.g. using A_{#3}* w_{#3}+A_{#4}*w_{#4}). The expected value can be thought of as a “soft output” of the SOM.

In a further example an ASOM associates objects with locations. When the SOM is queried with an object (a cup). If the most probable (single) location of a cup is desired, soft output should not be used. To retrieve a representation of all locations where a cup could be found (probability-weighted), soft output can be used.

1.-41. (canceled)

42. A machine-learning model-based combination chunker/planner system, the chunker/planner system comprising:
i. a machine learning component (“Sequencer”) configured for receiving sequential input, for dividing the sequential input into one or more chunks, and for generating a plan corresponding to each chunk; and
ii. a second machine learning component (“Planner”) configured for pursuing a reward, for selecting from plans generated by the Sequencer those plans most closely associated with reaping the reward in a current state, and for activating a selected plan.

43. The chunker/planner system of claim 42 wherein the Sequencer is further configured for dividing the sequential input based on an element selected from the group consisting of: receiving an explicit end-of-sequence input, reaching a maximum size for a current chunk, receiving a reward to associate with a current chunk, and receiving an input whose value differs from expected values by more than a set threshold.

44. The chunker/planner system of claim 42 wherein generating a plan corresponding to a chunk comprises:
i. generating a declarative representation (“tonic”) associated with the entire chunk; and
ii. as each element of the chunk is examined in input sequence:
1. querying the Planner for a complete plan consistent with the chunk as examined so far; and
2. using a complete plan returned by the Planner, the tonic, a time-decaying context, and a most recently examined element in the chunk to predict a next element in the chunk.

45. The chunker/planner system of claim 42:
i. wherein the Planner is further configured for associating with a plan a change of state produced when the plan is activated; and
ii. wherein the Planner is further configured for pursuing a goal state, for selecting from plans generated by the Sequencer those plans most closely associated with accomplishing a change of state from a current state to a state closer to the goal state, and for activating a selected plan.

46. The chunker/planner system of claim 42 further comprising an input buffer for the Sequencer; wherein the Sequencer is further configured to:
i. receive the sequential input into the input buffer;
ii. respond to a user command to discard the contents of the input buffer; and
iii. respond to a user command to train the Sequencer to turn the contents of the input buffer into a plan and to record it as a chunk.

47. The chunker/planner system of claim 42 further configured to:
i. receive a partial input;
ii. select a best match among existing plans that are consistent with the partial input;
iii. predict a result and reward from activating the selected plan; and
iv. activate the selected plan.

48. The chunker/planner system of claim 42 further configured to:
i. receive a partial input;
ii. infer a probability distribution of existing plans consistent with the partial input;
iii. predict a probability distribution of results and rewards from activating the consistent plans; and
iv. predict a next element in the input, the prediction based, at least in part, on the probability distribution.

49. The chunker/planner system of claim 42 wherein the Sequencer is a self organizing map.

50. The chunker/planner system of claim 42 wherein the Planner is a self organizing map.

51. In a computer-implemented system, a method for directing behaviour, the method comprising:
i. receiving, by a first machine learning component (“Sequencer”), sequential input;
ii. dividing the sequential input into one or more chunks;
iii. generating a plan corresponding to each chunk; and
iv. pursuing, by a second machine learning component (“Planner”), a reward, wherein pursuing a reward comprises selecting from plans generated by the Sequencer those plans most closely associated with reaping the reward in a current state and activating a selected plan.

52. The method for directing behaviour of claim 51 further comprising:
i. associating, by the Sequencer, with a plan a change of state produced when the plan is activated; and
ii. pursuing, by the Planner, a goal state, wherein pursuing a goal state comprises selecting from plans generated by the Sequencer those plans most closely associated with accomplishing a change of state from a current state to a state closer to the goal state and activating a selected plan.

53. A system for controlling an application, the system comprising:
i. a machine-learning model-based combination chunker/planner system comprising:
a first machine learning component (“Sequencer”) configured for receiving sequential input from the application, for dividing the sequential input into one or more chunks, and for generating a plan corresponding to each chunk; and
a second machine learning component (“Planner”) configured for pursuing a reward, for selecting from plans generated by the Sequencer those plans most closely associated with reaping the reward in a current state, and for activating a selected plan by communicating with the application;
ii. wherein the Sequencer is further configured for associating with a plan a change of state produced when the plan is activated; and
iii. wherein the Planner is further configured for pursuing a goal state, for selecting from plans generated by the Sequencer those plans most closely associated with accomplishing a change of state from a current state to a state closer to the goal state, and for activating a selected plan by communicating with the application.

54. The system of claim 53 wherein the controlled application is selected from the group consisting of: an industrial process, a manufacturing process, an online planning/collaboration application, and an online service avatar.

55. The system of claim 53 wherein the Sequencer is a self organizing map.

56. The system of claim 53 wherein the Planner is a self organizing map.

57. A machine-learning model-based system configured for detecting frequently occurring subsequences in sequential input and representing the subsequences as a whole, the system comprising: a neural-network self-organizing map (“Sequencer”) configured for receiving the sequential input, for dividing the sequential input into one or more subsequences, and for generating a plan corresponding to each subsequence.

58. The system of claim 57 wherein the Sequencer is further configured for dividing the sequential input based on an element selected from the group consisting of: receiving an explicit end-of-sequence input, and receiving an input whose value differs from expected values by more than a set threshold.

59. The system of claim 57 wherein generating a plan corresponding to a chunk comprises:
generating a declarative representation (“tonic”) associated with the entire chunk; and
as each element of the chunk is examined in input sequence:
using the tonic, a time-decaying context, and a most recently examined element in the chunk to predict a next element in the chunk.

60. The system of claim 57 further configured to:
receive as a partial input a fragment of a sequence;
select a best match among existing plans that are consistent with the partial input;
predict a likely next element in the sequential input from activating the selected plan; and
activate the selected plan.

61. The system of claim 57 further configured to:
receive as a partial input a fragment of a sequence;
infer a probability distribution of existing plans consistent with the partial input;
predict a probability distribution of likely next elements in the sequential input from activating the consistent plans; and
predict a next element in the input, the prediction based, at least in part, on the probability distribution.
